(19) United States
(12) Patent Application Publication
(10) Pub. No.: US 2004/0085722 A1
(43) Pub. Date: May 6, 2004

(54) Systems for storing data

(76) Inventors: Herbert J. Tanzer, Cool, CA (US); Patrick S. McGoey, Cameron Park, CA (US)

Correspondence Address: HEWLETT-PACKARD COMPANY, Intellectual Property Administration, P.O. Box 272400, Fort Collins, CO, 80527-2400, US

(21) Appl. No.: 10/287,249

(22) Filed: Nov. 4, 2002

(51) Int. Cl. G06F 1/16; G06F 13/00

(52) U.S. Cl. 361/683; 710/302

(57) ABSTRACT

Data storage systems are provided. One such data storage system includes a first data storage carrier. The first data storage carrier incorporates a hot-swappable communication connector and first and second disk drives mounted adjacent to each other in a side-by-side relationship. The first and second disk drives are addressable via a single data address using a data bus, with the first data storage carrier being removably mountable to an enclosure via the hot-swappable communication connector. Methods and other systems also are provided.

### BACKGROUND OF THE INVENTION

1. Field of the Invention

The present invention relates generally to data storage and, in particular, to data storage systems that provide increased data storage density.

2. Description of the Related Art

Data storage typically is accomplished in a commercial environment by using enclosures that mount multiple disk drives. Disk drives normally are mounted within data storage carriers that facilitate handling and cooling, for example, of the disk drives. Typically, each data storage carrier is configured to be mounted within a slot of such an enclosure.

A representative prior art data storage system is depicted schematically in FIG. 1. As shown in FIG. 1, data storage system 10 includes an enclosure 12 that defines an interior 14. Interior 14 is accessible via opening 16 which is sized to receive data storage carrier 10.

Data storage carrier 18 includes a single disk drive 20. The disk drive communicates with a communication connector 22 that enables the disk drive to communicate with a data bus or midplane 24 of the enclosure. Communication connector 22 facilitates communication by mating with a corresponding connector 26 of the midplane. Clearly, a relatively high degree of data storage density is provided by such a data storage system. Note, multiple enclosures, each of which mounts multiple carriers, can be mounted to a rack, thus forming a conventional rack-mounted configuration.

As advances in technology enable the size of disk drives to be reduced, legacy enclosures, such as enclosure 12 of FIG. 1, typically become obsolete. This is because the openings of the enclosures are sized to receive data storage carriers of a specific size. Thus, when a data storage carrier is reconfigured to mount a disk drive of reduced size, such a legacy enclosure may not be able to mount the reconfigured data storage carrier. Therefore, it should be understood that there is a need for improved systems and methods that address these and/or other perceived shortcomings of the prior art.

### SUMMARY OF THE INVENTION

Briefly described, the present invention involves the use of data storage carriers that accommodate multiple disk drives. In this regard, an embodiment of a data storage system in accordance with the invention includes a data storage carrier that incorporates a housing and an interface. The housing defines an interior that is sized and shaped to receive multiple disk drives. The interface is mounted to the housing and includes a controller, and first, second and third communication connectors, each of which communicates with the controller. In particular, each of the second and third communication connectors is configured to communicate data to a corresponding one of the multiple disk drives, and the first communication connector is configured to communicate with a data bus so that data is provided from the data bus to the controller. The controller is operative to control data flow control between the first connection and the second and third connectors.

Another embodiment of a data storage system in accordance with the invention includes a first data storage carrier. The first data storage carrier incorporates a hot-swappable communication connector and first and second disk drives mounted adjacent to each other in a side-by-side relationship. The first and second disk drives are addressable via a single data address using a data bus, with the first data storage carrier being removably mountable to an enclosure via the hot-swappable communication connector.

An embodiment of a method in accordance with the invention comprises providing a carrier having multiple disk drives and enabling the disk drives of the carrier to be provided with data via a single data address.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of a prior art data storage system.

FIG. 2 is a schematic diagram of an embodiment of a data storage system in accordance with the present invention.

FIG. 3 is a schematic diagram of an embodiment of a data interface bus in accordance with the invention that can be used in a data storage carrier.

FIG. 4 is a schematic diagram of an embodiment of a data storage carrier in accordance with the invention.

FIGS. 5 is a perspective view of the embodiment of FIG. 4 showing detail of the disk drives and data interface bus.

FIG. 6 is a partially-exploded, perspective view of the embodiment of the carrier depicted in FIG. 4.

FIG. 7 is a cut-away, side view of the embodiment of the carrier depicted in FIG. 4.

FIG. 8 is a partially-exploded, perspective, rear view of the bezel of the carrier depicted in FIG. 4, showing assembly detail of the thumb latch.

FIG. 9 is a cut-away, perspective view of an embodiment of a chassis in accordance with the present invention that is configured to mount one or more carriers in a vertical orientation.

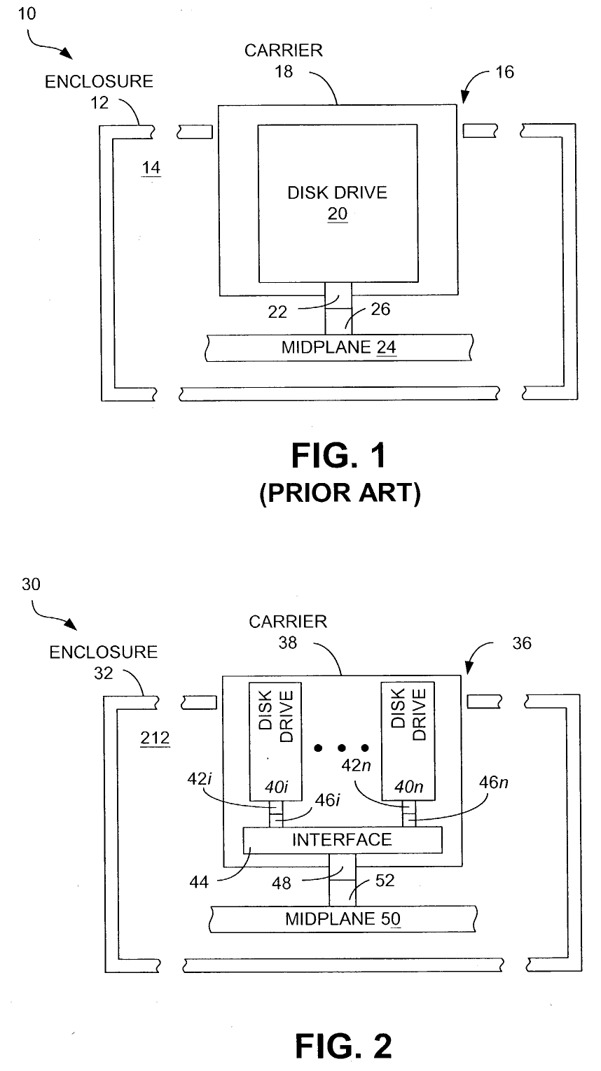

### DETAILED DESCRIPTION

As will be described in detail here, data storage systems in accordance with the invention can, for example, extend the useful life of legacy data storage enclosures that were originally designed to accommodate single disk drive carriers. This is accomplished by providing carriers that incorporate multiple disk drives. Since, in some embodiments, the data storage carrier is sized to be mounted to a legacy enclosure, providing multiple disk drives within the data storage carrier increases the data storage density of the enclosure. As should be understood, this can alleviate the need for discarding an enclosure when reduced sized disk drives become available. Clearly, however, embodiments of the invention are not limited to use with such legacy enclosures.

Referring now to the drawings, FIG. 2 is a schematic diagram depicting an embodiment of a data storage system in accordance with the invention. As shown in FIG. 2, data storage system 30 includes an enclosure 32 that defines an interior 34. Interior 34 is accessible via opening 36 that is sized to receive data storage carrier 38. Note, only one opening and one corresponding data storage carrier are shown in FIG. 2 for ease of description, although various numbers of openings and carriers can be provided.

Data storage carrier 38 includes multiple disk drives (40i-40n). Each disk drive communicates with a communication connector (42i-42n) that enables the disk drive to communicate with an interface 44 of the data storage carrier. Each of the communication connectors 42i-42n mates with a corresponding communication connector (46i-46n) of the interface.

The interface 44 also includes a communication connector 48 that mates with a corresponding connector of the enclosure. More specifically, midplane 50 of the enclosure includes one or more communication connectors, e.g., connector 52, each of which is configured to facilitate communication of the midplane with a data storage carrier. Thus, in the embodiment of FIG. 2, connector 48 of carrier 38 mates with connector 52 of the midplane and enables the disk drives of carrier 38 to communicate with the midplane of enclosure 32.

By providing multiple disk drives within a single carrier, some inherent limitations associated with using a single disk drive-carrier configuration can be overcome. By way of example, when the disk drive is a 2.5 inch small form factor (SFF) disk drive, such a disk drive is small enough to cause difficulty during user handling. In particular, in a high-density data-storage application where the drives are located close to each other, it can be difficult for a user to grasp a designated drive, such as when the drive is to be replaced. Therefore, by arranging multiple disk drives within a carrier, an entire carrier could be removed from an enclosure when maintenance or another operation is to be performed with respect to one of the accompanying disk drives. The entire carrier then can be transported to a suitable working environment for servicing the disk drive.

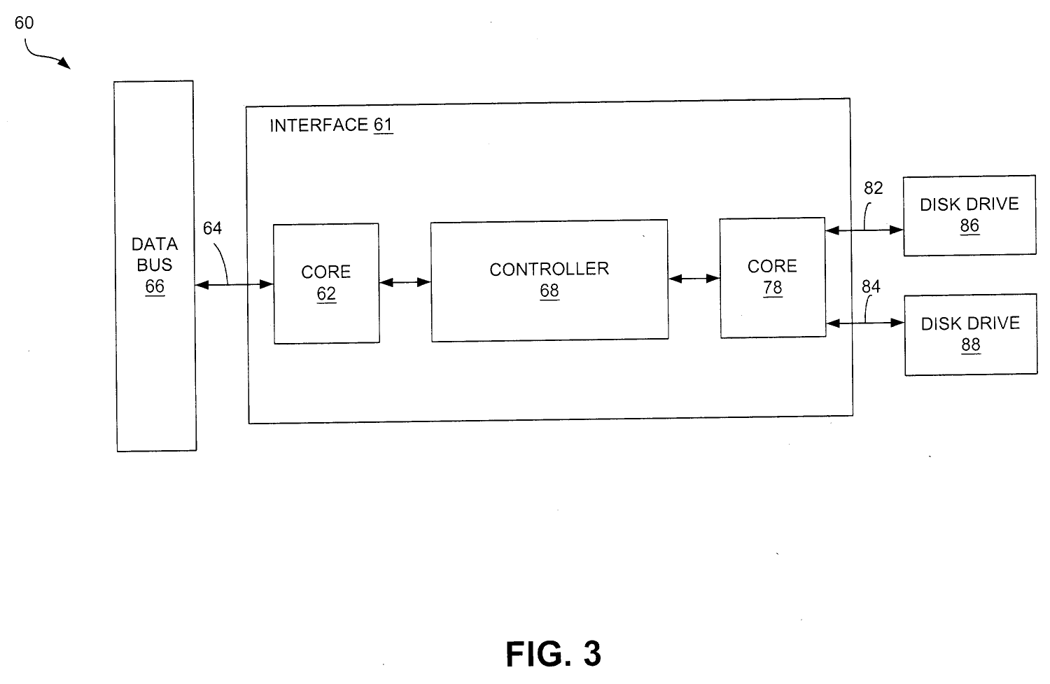

Another embodiment of a data storage system is depicted schematically in FIG. 3. In FIG. 3, data storage system 60 includes an interface 61 that can be used for communicating data between the disk drives of a carrier and an enclosure midplane. Interface 61 includes a first core 62 and an associated connector 64 that enable the interface to communicate with a data bus 66. First core 62 communicates with a controller 76. Controller 76 controls the flow of data between the first core 62 and a second core 78. Note, in some embodiments, the controllers can include components such as buffers for enabling data routing.

Typically, controller 76 is a processor-based device that routes data among the disk drives in a random-array of independent disks (RAID) format, although other data-routing formats can be used. In such an embodiment, the interface and associated controller enable the carrier to function as a single addressable block of disk drives with data storage redundancy. Note, the controller can be used to facilitate hot-swappable connectivity by controlling the aforementioned data interrupts.

Core 78 includes communication connectors 82 and 84, each of which communicates with a disk drive. In FIG. 3, connector 82 communicates with disk drive 86 and connector 84 communicates with disk drive 88. Note, connectors 82 and 84 preferably are cold-swappable connectors in contrast to connector 64, which preferably is hot-swappable, i.e., connector 64 can be disconnected from bus 66 without removing power from the interface. Typically, hot-swappable capability involves the use of one or more of staggered pin lengths of the pins of the connector and control of data interrupts.

By treating the multiple disk drives of the carrier as a single addressable target, parallel processing of data can be used to overcome a read/write dataflow bottleneck that is typically exhibited by disk drives such as disk drives. By way of example, received data can be striped across the set of disk drives. That is, a first portion of data received can be directed for storage at a first of the disk drives, e.g., drive 86, a second portion of data can be directed for storage at a second of the disk drives, e.g., drive 88, and so on, until a portion of data has been stored at each of the disk drives. Subsequent portions of data then can be saved in a similar manner. Thus, any latency exhibited by a disk drive can be overcome by intermittently providing data to or receiving data from the disk drive.

Various types of interfaces, i.e., cores and associated connectors, can be used. By way of example, SATA, SAS, FC, SCSI, IDE and IB cores and/or connectors could be used. Typically, the cores used in a particular data storage system are dissimilar. By way of example, the first core can be an SCSI core and the second core can be an IDE core. In other embodiments, however, the first and second cores can be similar. For instance, the first and second cores both can be SCSI cores. In such an embodiment, the “controller” used for routing data between the cores could be a component such as a logical bus extender that enables data directed to a single address to be directed to multiple disk drives. Note, the invention also could be adapted to accommodate later-developed interface and/or connector types.

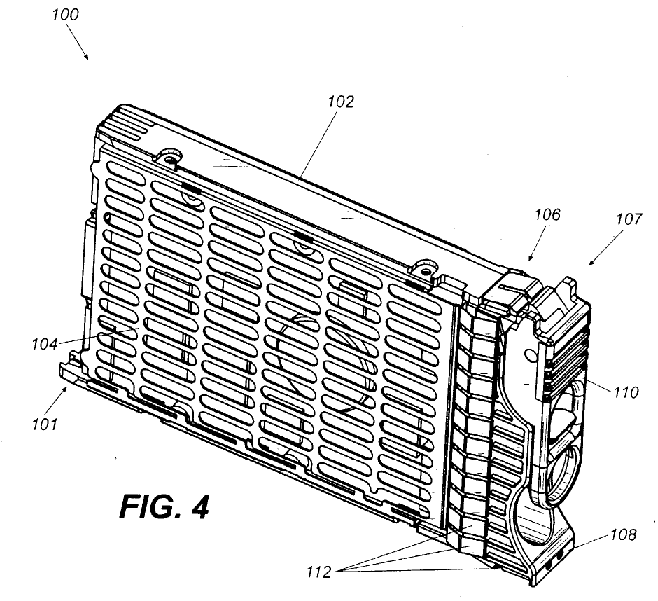

An embodiment of a carrier 100 that includes multiple disk drives is depicted in FIG. 4. As shown in FIG. 4, carrier 100 includes a housing 101, which incorporates a carrier frame 102 and a protective circuit assembly (PCA) cover 104. Frame 102 is sized and shaped for receiving and mounting the disk drives. At least partial encasement of the disk drives within carrier 100 is facilitated by PCA cover 104. PCA cover 104 is adapted to mate with the carrier frame 102. Once so mated, carrier frame 102, PCA cover 104, and corresponding disk drives cooperate so as to provide a protective enclosure for more sensitive portions of the disk drives, such as storage device circuit assemblies (not shown). For example, and not for the purpose of limitation, a storage device circuit assembly may be positioned between the PCA cover 104 and an opposing exterior surface of one of the disk drives.

In addition to providing a protective enclosure for the disk drives, in some embodiments, PCA cover 104 can function as a heat sink. In these embodiments, the PCA cover can be formed of a material such as aluminum, for example.

As shown in the embodiment of FIG. 4, carrier 100 includes an EMI shield 106, and a handle assembly 107, which incorporates a carrier bezel 108 and a handle 110. In some embodiments, handle 110 provides the dual functionality of serving as a carrying handle, which may be utilized for repositioning the carrier, and a locking mechanism for facilitating secure mounting of the carrier to an appropriate chassis or other mounting device. Preferably, the EMI shield incorporates spring fingers 112, described in detail hereinafter.

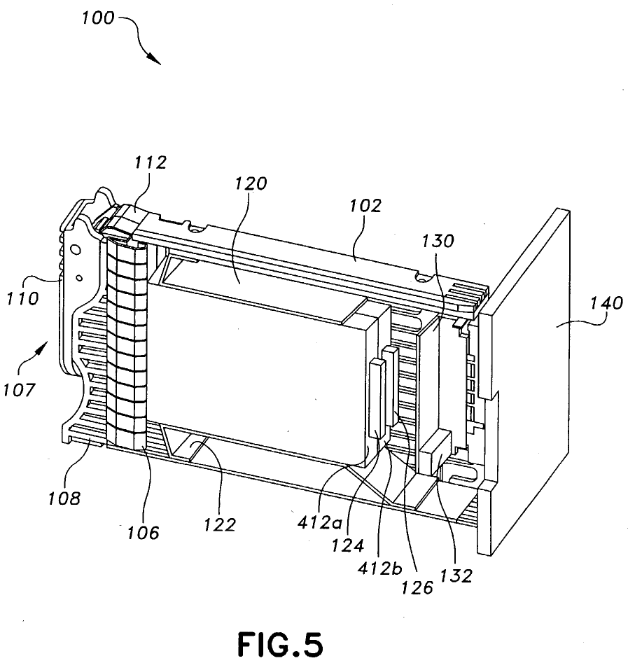

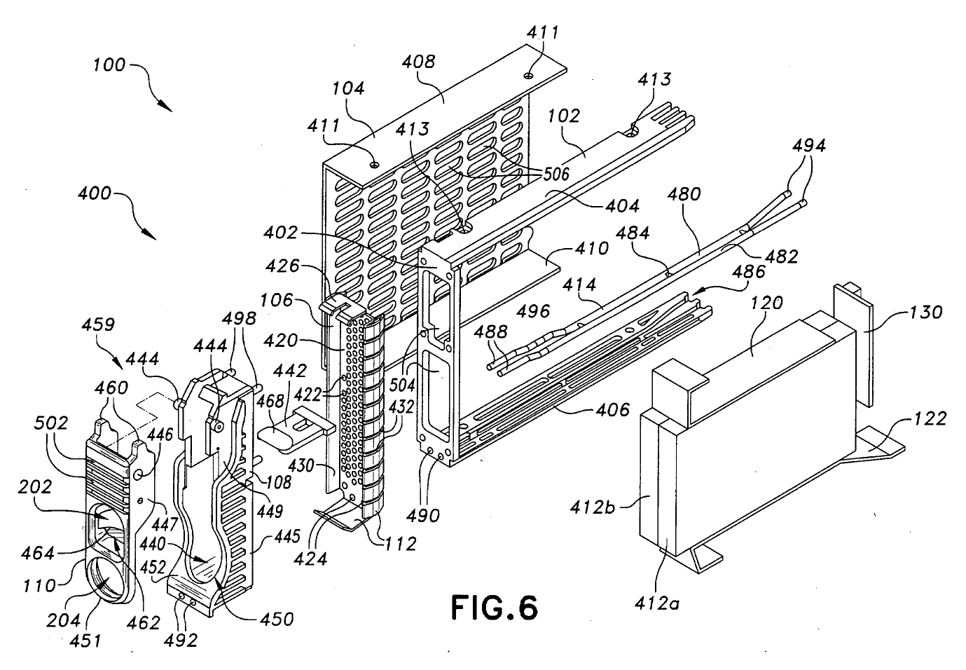

Reference will now be made to FIGS. 5 and 6, which depict assembly detail of the embodiment of the carrier 100 depicted in FIG. 4. Note, additional information on carriers, such as carrier 100, is provided in U.S. patent applications Ser. No. 09/896,478 (10011400-1, 50819-1110), entitled “Systems for Mounting Data Storage Devices,” filed on Jun. 29, 2001; Ser. No. 10/014,077 (10011678-1, 50819-1410), entitled “Systems for Use with Data Storage Devices,” filed Dec. 11, 2001; Ser. No. 09/970,189 (10011679-1, 50819-1420), entitled “Systems for Mounting Electronic Component Carriers,” filed Oct. 3, 2001; Ser. No. 10/014,905 (10012385, 50819-1540), entitled “Data Storage Systems with Enhanced Cooling,” filed Dec. 11, 2001; and Ser. No. 09/991,095 (10018387-1,50830-1220), entitled “Systems with Pedestal Stands for Mounting Components,” filed on Nov. 16, 2001. These applications are commonly assigned to the Hewlett-Packard Company and are incorporated herein by reference.

As shown in FIGS. 5 and 6, carrier 100 includes frame 102, PCA cover 104, EMI shield 106, bezel 108, and cam handle 110. Frame 102 incorporates a face plate 402 and rails 404 and 406, which extend outwardly from face plate 402. Frame 102 is configured to receive PCA cover 104. By way of example, in the embodiment depicted in FIGS. 5 and 6, sidewalls 408 and 410 of PCA cover 104 engage between rails 404 and 406, respectively, of frame 102. Sidewalls 408 and 410 are appropriately spaced to receive disk drives, e.g., disk drives 412a and 412b. Thus, the disk drives are received at least partially between sidewalls 408 and 410.

Disk drives 412a and 412b are mounted to frame 102 by mounting brackets 120 and 122. The brackets are sized and shaped to mechanically support and position the disk drives in a generally central portion of the interior of the carrier 100. In the embodiment of FIGS. 5 and 6, each of the mounting brackets is attached to a corresponding rail of the frame.

Disk drive 412a includes a connector 124 and disk drive 412b includes a connector 126 that is used for communicating data to and/or from interface 130. Although not shown in FIGS. 5 or 6, communication between connectors 124 and 126 and interface 130 can be facilitated by a transmission medium, such as a flex cable. Interface 130 includes a controller 132 and associated components (not shown) that enable signals to be routed to and/or from midplane 140. Note, midplane 140 depicted in FIG. 5 is a cut-away portion of a corresponding enclosure and is not a constituent component of carrier 100.

Frame 102 is adapted to engage a lightpipe assembly 414, which will be described in detail hereinafter. Additionally, frame 102 and, more specifically, faceplate 402, is adapted to engage EMI shield 106. EMI shield 106 includes a body portion 420 that defines various apertures. In particular, an array of apertures 422 is provided, with the apertures 422 being sized and shaped to impede and/or prevent the propagation of electromagnetic energy from components arranged behind shield 106, e.g., disk drives 412a and 412b. In some embodiments, apertures 422 each are configured with a hexagonal shape and also provide the function of enabling air to flow through the shield. This configuration tends to promote cooling of the disk drives. Body portion 420 also includes apertures 424 that are adapted to facilitate placement and/or viewing of lightpipe assembly 414.

Preferably, spring fingers 112 depend from body portion 420, such as along an outer periphery of the body portion. Various numbers and configurations of spring fingers 112 may be provided. All such numbers and configurations are considered well within the scope of the invention. The spring fingers preferably provide one or more of the following functions: (1) promoting structural stability to reduce externally and/or internally generated shock and/or vibration; (2) promoting electrical grounding continuity between carrier 100 and a component(s) to which it is mounted, and/or other carriers of such a component(s); and (3) enhancing EMI and/or ESD control of the carrier.

Various aspects of enhancing EMI and/or ESD control of a carrier/chassis system are described in detail in co-pending U.S. patent application Ser. No. 09/809,409 (10012052-1, 50819-1490), entitled “Systems with Enhanced Electrostatic Discharge Protection,” filed on Mar. 15, 2001. That application is commonly assigned to the Hewlett-Packard Company and is incorporated herein by reference.

In FIG. 4, EMI shield 106 includes both forward-facing spring fingers 426 and rearward-facing spring fingers 428 (forward-facing generally referring to a direction away from disk drive 412, and rearward-facing generally referring to a direction toward device 412). Spring fingers 428 preferably extend from flanges 430, which, in combination with the forward-facing spring fingers 426, are adapted to extend about at least a portion of bezel 108.

EMI shield 106 is formed, at least partially, of an appropriate shielding material, such as stainless steel, among others. EMI shield 106 is formed of an appropriate thickness of material or otherwise is configured so as to provide suitable flexibility to one or more of the various spring fingers 112. So formed, the spring fingers preferably deflect in response to a displacement force, such as when engaging a corresponding portion of a chassis cage slot, for example. As the spring fingers tend to be biased to their non-displaced positions (shown in FIGS. 5 and 6), this configuration enables the flexible spring fingers to serve as dampers for damping encountered shock and/or vibration of the carrier. The flexible configuration of the spring fingers also accommodates variable pitch arrangements of multiple carriers. Additionally, slots 432 formed between adjacent ones of the spring fingers may be appropriately sized and shaped for inhibiting propagation of electromagnetic energy beyond the material of the spring fingers.

The structure and accompanying functionality of bezel 108 and cam handle 110 will now be described. As shown in FIGS. 5 and 6, bezel 108 defines an interior cavity 440 that is adapted to receive a thumb latch 442 (described hereinafter). Pivot bosses 444 are adapted to be received within corresponding pivot holes 446 of cam handle 110. Pivot bosses 444 preferably are provided on sidewalls 445 of the bezel, with pivot holes 446 preferably being formed through sidewalls 447 of the cam handle. Engagement of the bosses 444 within the holes 446 permits pivoting of cam handle 110 about the bosses 444 between an open or unlatched position (not shown) and a closed or latched position 501 (depicted in FIG. 6).

As shown in FIGS. 5 and 6, each of bezel sidewalls 445 preferably incorporates a recessed portion 449 that is adapted to facilitate seating of the cam handle sidewalls 447 when the cam handle is in the latched position. In the embodiment depicted in FIG. 4, the surface defining each bezel sidewall recessed portion 449 extends to form a contoured profile of the bezel that provides appropriate clearance between the bezel and portions of the cam handle during pivoting of the cam handle. This feature also may be seen in FIG. 6, for example.

Bezel 108 preferably includes a recessed portion 450 that is adapted to provide clearance between the distal end 451 of the cam handle and the face 452 of the bezel. This recessed portion enables a finger of a user to be inserted between the distal end of the cam handle and the bezel so as to facilitate grasping and pivoting of the cam handle.

In order to facilitate mounting of carrier 100 into a corresponding chassis cage slot, for example, cam handle 110 incorporates a latching mechanism 459, which can be configured as one or more cam latches 460. In a preferred embodiment, dual cam latches 460 are provided, with each of the latches extending generally upwardly from a sidewall 447 of the cam handle. Cam latches 460 facilitate mounting of the carrier 100 by engaging a corresponding latching surface, such as representative latching surface 510, depicted in FIG. 6. Preferably, spacing of the cam latches from each other is sufficient to enable nesting of the cam latches about a rail of an adjacently disposed carrier. Thus, line-to-line stacking of carriers can be accommodated in some embodiments.

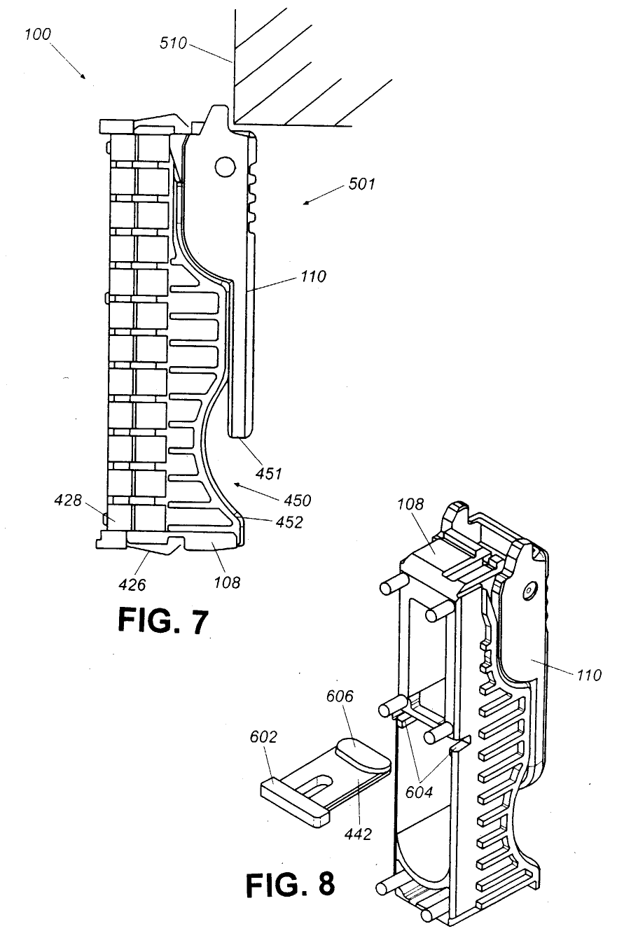

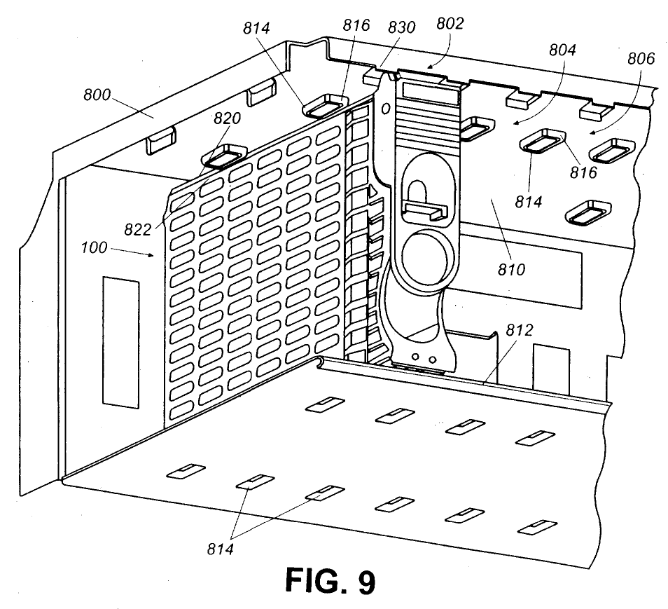

As mentioned hereinbefore, bezel 108 receives thumb latch 442. As depicted in FIG. 7, thumb latch 442 is received by bezel 108 by positioning base 602 of the latch within corresponding notches 604 of the bezel. Once so positioned, a protrusion 606 extends through bezel opening 440 and, thus, is appropriately positioned to be received within slot 462 of the cam handle (FIGS. 5 and 6). In operation, as cam handle 110 is pivoted from the unlatched position to the latched position (depicted in FIG. 6), protrusion 606 is received within slot 462. Thereafter, further rotation of the cam handle toward the latched position causes protrusion 606 to be downwardly deflected until lip 464 of the cam handle extends beyond ledge 468 of the latching member. The downwardly deflected protrusion 606 returns to its unbiased position, thereby forming an interference fit between lip 464 and protrusion 606. The aforementioned interference fit tends to maintain the cam handle in the latched position.

Rotation of the cam handle from the latched position to the unlatched position preferably is facilitated by the user extending a thumb, for example, into opening 202 of the cam handle. The thumb then engages thumb latch 442 and downwardly deflects latching member 606 until the interference fit is disengaged. Thereafter, the cam handle may be rotated toward its unlatched position. This can be accomplished by the user inserting another finger, e.g., an index finger, into opening 204 and grasping the cam handle between the thumb and finger.

Various openings are provided within and through the carrier to promote cooling of a disk drive. For instance, cam handle 110 includes one or more louvers 502 that, in addition to the thumb opening 202 and finger opening 204, are adapted to permit air to flow through the handle. Once passing through the handle, air can flow through cavity 440 of the bezel, and then through the various apertures 422 of the EMI shield 106. After passing through the EMI shield, air can reach disk drive 412 by passing through one or more frame openings 504. Airflow toward and away from the disk drive also is provided by apertures 506 formed through the PCA cover 104. Various materials for promoting cooling of heat-producing components and/or protecting a user from such components may be utilized.

Lightpipe assembly 414 will now be described in greater detail. Lightpipe assembly 414 preferably includes two lightpipes, lightpipes 480 and 482, respectively, that are interconnected by one or more cross ties 484. It should be noted that various other numbers of lightpipes may be utilized in other embodiments, with all such numbers being considered well within the scope of the present invention.

The preferred configuration depicted in FIGS. 5 and 6 enables lightpipe assembly 414 to be assembled during a single molding operation. In particular, lightpipe assembly 414 can be formed by pouring material into a suitable mold to form both lightpipes and their accompanying cross ties as a unitary structure.

Lightpipe assembly 414 is received within a channel arrangement (pocket) 486 that is formed within a rail of frame 102. Once received within pocket 486, viewing ends 488 of the lightpipes may be viewable and/or extend at least partially through holes 490 of frame 102, holes 424 of EMI shield 106, and holes 492 of bezel 108. So provided, status light information typically provided by one or more light emitting diodes (LEDs) associated with the cage slot of a chassis may be propagated to the user for viewing.

In order to increase the chance for light emitted from the aforementioned LEDs (not shown) to enter the lightpipes, light acceptance cones 494 may be provided at the LED ends of the lightpipes. As the cones have an increased cross-sectional surface area at their distal ends, as compared to the cross-sectional surface area of the cylindrical-shaped portions of the lightpipes, minor misalignment of the lightpipes with the LEDs of the cage slot may be accommodated. Thus, this configuration preferably enables a sufficient amount of light from the LEDs to be propagated through the lightpipes for viewing.

In order to keep lightpipe-to-lightpipe crosstalk to negligible visibility levels, an incident light separator 496 preferably is disposed within the pocket 486. Separator 496 forms a physical partition between the lightpipes that is able to reduce the tendency of and/or prevent incident light from propagating between the lightpipes. At locations where the separator is not present, such as at occurrences of cross ties 484, for example, crosstalk between the lightpipes can be reduced by providing the cross ties with a surface texture that promotes scattering of light. For instance, if the cross ties are configured with a non-smooth surface texture, light provided to the cross ties can tend to scatter and not propagate at full intensity from one lightpipe to the other via the cross ties.

Referring now to FIG. 8, mounting of a carrier 100 to a representative chassis will be described. In FIG. 8, chassis 800 defines multiple slots, e.g., slots 802, 804 and 806, which can accommodate a carrier 100. A carrier 100 is depicted mounted within slot 802 in a vertical mounting position. Slot 802 is defined, at least in part, by an upper wall 810 and a lower wall 812. The walls are spaced from each other at a distance that is sufficient to receive carrier 100. Protrusions 814, some of which extend downwardly from upper wall 810 while others extend upwardly from lower wall 812, are configured to function as alignment guides for the carrier. More specifically, protrusions 814 are configured to engage one or more surfaces of the carrier and tend to align the carrier with its slot as the carrier is slid into the slot. In the embodiment of FIG. 8, protrusions 14 include generally rounded, or otherwise angled, front surfaces 816 that tend to deflect a mis-aligned carrier toward a proper mounting position. The protrusions, which may be configured to engage various surface of a carrier, preferably engage reveal 820. Reveal 820 is defined where the upper portion 822 and lower portion (not shown) of the PCA cover 104 engage the frame rails.

In order to mount the carrier within slot 802, the handle preferably is pivoted to its unlatched position. The carrier is aligned with the slot and inserted rearwardly into the slot. The protrusions 814 preferably align the carrier and permit the carrier to be slid into the chassis to a sufficient depth to enable the cam latches of the handle to pass beyond a latching surface provided by the chassis. In some embodiments, such a latching surface can be formed by a protrusion 830 arranged in the upper wall of the chassis. Once inserted to an appropriate depth, the handle can be pivoted to its latched position so that the cam latches engage the latching surface(s). This secures the carrier within the slot.

It should be emphasized that the above-described embodiments of the present invention are merely possible examples of implementations set forth for a clear understanding of the principles of the invention. Many variations and modifications may be made to the above-described embodiments of the invention without departing substantially from the principles of the invention. By way of example, various shapes and sizes of carriers can be used, provided that the carriers can accommodate mounting of multiple disk drives. All such modifications and variations are intended to be included herein within the scope of this disclosure and the present invention and protected by the following claims.

1. A data storage system comprising:
a data storage carrier having:
a housing defining an interior, the interior being sized and shaped to receive multiple disk drives; and
an interface mounted to the housing, the interface having a controller, a first communication connector, a second communication connector, and a third communication connector, each of the connectors communicating with the controller, each of the second and third communication connectors being configured to communicate data to a corresponding one of the multiple disk drives, the first communication connector being configured to communicate with a data bus such that data is provided from the data bus to the controller, the controller being operative to control data flow between the first connector and the second and third connectors.

2. The data storage system of claim 1, further comprising:
a first disk drive having a fourth communication connector configured to mate with and communicate data to and from the second communication connector; and
a second disk drive having a fifth communication connector configured to mate with and communicate data to and from the third communication connector, each of the disk drives being addressable as a single data storage target such that data is provided to the interface from a data bus and stored among the first and second disk drives.

3. The data storage system of claim 2, wherein the controller is operative to stripe the data across the first and second disk drives.

4. The data storage system of claim 2, wherein the carrier further comprises:
means for striping data across the first and second disk drives.

5. The data storage system of claim 2, further comprising:
an enclosure defining an enclosure interior and an enclosure opening, the enclosure opening being sized and shaped to receive the data storage carrier such that the data storage carrier is insertable into the enclosure interior through the enclosure opening, the enclosure having a data bus and a sixth communication connector communicating with the data bus, the fourth communication connector being accessible via the enclosure interior and being configured to mate with the first communication connector such that the first and second disk drives communicate with the data bus via the interface.

6. The data storage system of claim 2, wherein the housing comprises:
a shield configured to inhibit propagation of electromagnetic energy directed from the disk drive and toward said shield; and
a frame engaging said shield, said frame having a faceplate, a first rail, and a second rail, said first rail and said second rail being space from each other and extending from said faceplate such that said first and second disk drives are arranged between said first and second rails.

7. The system of claim 6, wherein said carrier further comprises:
a latching mechanism engaging said housing and configured to engage a latching surface of a chassis such that, when the carrier is received by a chassis and the handle is moved to a latched position, engagement of the latching mechanism with the latching surface substantially prevents the carrier from being removed from the chassis.

8. The system of claim 7, wherein the carrier has spring fingers arranged at least partially between the handle assembly and the housing, each of the spring fingers being configured as a flexible member, the spring fingers being spaced from each other and protruding about at least a portion of the periphery of the carrier, each of the spring fingers being configured to deflect from a non-displaced position in response to a displacement force such that the spring fingers tend to damp vibration encountered by the carrier.

9. The data storage system of claim 1, wherein the interior is sized to receive a 3.5″ FF disk drive.

10. The data storage system of claim 9, further comprising:
multiple 2.5″FF disk drives mounted within the interior.

11. The data storage system of claim 1, wherein the first communication connector is a hot-swappable connector.

12. A data storage system for use with a data bus, said data storage system comprising:
a first data storage carrier having a hot-swappable communication connector and first and second disk drives mounted adjacent to each other in a side-by-side relationship, the first and second disk drives being addressable via a single data address using the data bus, the first data storage carrier being removably mountable to an enclosure via the hot-swappable communication connector.

13. The data storage system of claim 12, wherein the first data storage carrier further comprises:
a controller communicating with the first and second disk drives and being operative to enable sequential portions of the data received at the single data address of the first data storage carrier to be directed selectively to the disk drives.

14. The data storage system of claim 12, wherein the first data storage carrier further comprises:
an interface having a controller and a first communication connector, a second communication connector, and a third communication connector, each of which communicates with the controller, the second communication connector and the third communication connector being configured to communicate data to the first and second disk drives, respectively, the first communication connector being configured to communicate with the data bus such that data is provided from the data bus to the controller, the controller being operative to control data flow to the second and third connectors for storage by the first and second disk drives.

15. A method for storing data comprising:
providing a carrier having multiple disk drives; and
enabling the disk drives of the carrier to be provided with data via a single data address.

16. The method of claim 15, further comprising:
enabling data to be striped across the disk drives.

17. The method of claim 15, wherein the carrier is configured to receive a single disk drive; and
further comprising:
enabling the single disk drive to be removed from the carrier; and
replacing the single disk drive with at least two additional disk drives, each of which exhibits a smaller form factor than the single disk drive
